(19) United States
(12) Patent Application Publication
(10) Pub. No.: US 2013/0193180 A1
(43) Pub. Date: Aug. 1, 2013

(54) AMPOULE BREAKAGE DEVICE AND METHODS OF OPERATION

(71) Applicant: Spectra Medical Devices, Inc., Wilmington, DE (US)

(72) Inventor: Anthony C. ARRIGO, North Andover, MA (US)

(73) Assignee: Spectra Medical Devices, Inc., Wilmington, DE (US)

(21) Appl. No.: 13/750,820

(22) Filed: Jan. 25, 2013

Related U.S. Application Data
(60) Provisional application No. 61/591,583, filed on Jan. 27, 2012.

(51) Int. Cl. B67B 7/92

(52) U.S. Cl. CPC B67B 7/92
USPC 225/1; 225/93

(57) ABSTRACT

An apparatus for removing a tip of an ampoule including a hollow cylindrical body including an outer cylindrical wall and an inner cylindrical wall. A plurality of longitudinal ridges project radially inward from the inner cylindrical wall of the hollow cylindrical body.

### CROSS REFERENCE TO RELATED APPLICATIONS

The present application claims priority to U.S. Provisional Application No. 61/591,583, tiled Jan. 27, 2012, entitled “AMPOULE BREAKAGE DEVICE,” which application is incorporated herein by reference in its entirety.

### TECHNICAL FIELD

The present embodiments relate generally to an ampoule breakage device for opening an ampoule and methods of using the ampoule breakage device to open the ampoule.

### BACKGROUND

Ampoules are small vessels that contain and preserve a sample, such as a solid or liquid. Often the sample is a drug used to treat a patient. Ampoules are typically sealed before the sample contained in the ampoule is consumed to ensure sterility of the sample. To access the sample, the tip or cap of an ampoule is removed. The tip of the ampoule may be removed by snapping or breaking the tip off from the remainder of the ampoule body. Many ampoules are made of glass.

A breakage device can be placed over the tip of the ampoule to assist in the removal of the tip. The breakage device may be designed to protect against glass splinters and/or to prevent cross-contamination. One disadvantage of known ampoule breakage devices includes the failure of the ampoule breakage devices to remove the tip of the ampoule at a desired location. Existing ampoule breakage devices may also fail to cleanly remove the tip of the ampoule, resulting in an opened end of the ampoule that has jagged edges. Existing ampoule breakage devices may also cause pieces of the ampoule to fly off when the tip of the ampoule is removed and may fail to maintain the tip of the ampoule breakage device after the tip is removed.

### SUMMARY

The present application relates generally to an ampoule breakage device.

Various exemplary embodiments provide an apparatus for removing a tip of an ampoule. Various embodiments of the apparatus include a hollow cylindrical body including an outer cylindrical wall having a first diameter and an inner cylindrical wall having a second diameter, where the second diameter is smaller than the first diameter. The hollow cylindrical body has a durometer less than or equal to 90 shore A. The apparatus further includes a plurality of ridges projecting radially inward from the inner cylindrical wall of the hollow cylindrical body. The plurality of ridges may extend longitudinally from a first end of the inner cylindrical wall to a second end of the cylindrical wall. The plurality of ridges project radially inward to a third diameter from the first end to the second end, in accordance with various embodiments. The second diameter of the inner cylindrical wall may be constant from the first end of the cylindrical wall to the second end. The plurality of ridges may have a semi-cylindrical cross section. In accordance with various embodiments, the hollow cylindrical body is composed of a flexible polyvinyl chloride. The hollow cylindrical body is colored red, in accordance with some embodiments. The red hollow cylindrical body may be at least partially opaque. In accordance with some embodiments, the plurality of ridges includes 3 to 4 ridges. Each ridge in the plurality of ridges may project 0.025 inches or less radially inward from the inner cylindrical wall.

One exemplary embodiment provides an apparatus for removing a tip of an ampoule that includes a hollow cylindrical body including an outer cylindrical wall having a first diameter and an inner cylindrical wall having a second diameter. The second diameter is smaller than the first diameter and the first diameter and the second diameter are maintained at a substantially constant diameter from the first end to the second end. The apparatus further includes a plurality of ridges projecting radially inward from the inner cylindrical wall of the hollow cylindrical body such that a tip of each ridge in the plurality of ridges is configured to engage the tip of the ampoule. The plurality of ridges extends longitudinally along the inner cylindrical wall, and the plurality of ridges project from the inner cylindrical wall a uniform distance along the length of the ridge.

Another exemplary inventive embodiment provides a method of breaking a tip of an ampoule. The method includes sliding an ampoule breakage device over the tip of the ampoule. The ampoule breakage device includes a hollow cylindrical body having an outer cylindrical wall, an inner cylindrical wall, and a plurality of longitudinal ridges extending along the hollow cylindrical body. The plurality of longitudinal ridges project radially inward from the inner cylindrical wall of the hollow cylindrical body. The plurality of longitudinal ridges project from the inner cylindrical wall a uniform distance such that an annulus is defined having a diameter limited by the plurality of ridges. The diameter of the annulus defined by the plurality of longitudinal ridges substantially corresponds to a diameter of a largest bulbous portion of the tip of the ampoule. The ampoule breakage device is slid over the tip of the ampoule until a first end of ampoule breakage device extends to at least a neck of the ampoule and the plurality of ridges engage the largest bulbous portion of the tip of the ampoule. The method further includes rotating the ampoule breakage device to break the tip of the ampoule at the neck, whereby the tip of the ampoule is securely maintained in the ampoule breakage device through engagement of the largest bulbous portion of the tip of the ampoule with the plurality of longitudinal ridges.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

### BRIEF DESCRIPTION OF THE DRAWINGS

The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally similar and/or structurally similar elements).

FIG. 1 is a top, cross-sectional view of an ampoule breakage device in accordance with an exemplary embodiment.

FIG. 2 is a side view of the ampoule breakage device of FIG. 1.

FIG. 3 is a side view of an ampoule and the ampoule breakage device of FIG. 1.

FIG. 4 is a top, cross-sectional view of an ampoule breakage device positioned about the tip of an ampoule in accordance with an exemplary embodiment.

The features and advantages of various inventive embodiments will become more apparent from the detailed description set forth below when taken in conjunction with the drawings.

### DETAILED DESCRIPTION

Following below are more detailed descriptions of various concepts related to, and embodiments of, inventive apparatuses and methods for breaking or removing a tip of an ampoule. It should be appreciated that various concepts introduced above and discussed in greater detail below may be implemented in any of numerous ways, as the disclosed concepts are not limited to any particular manner of implementation. Examples of specific implementations and applications are provided primarily for illustrative purposes.

Presently preferred embodiments are illustrated in the drawings. The disclosure relates to an ampoule breakage device for opening an ampoule. The ampoule breakage device may be used to remove the tip or cap of an ampoule, along the collar of the ampoule, at any time prior to use of a sample within the ampoule.

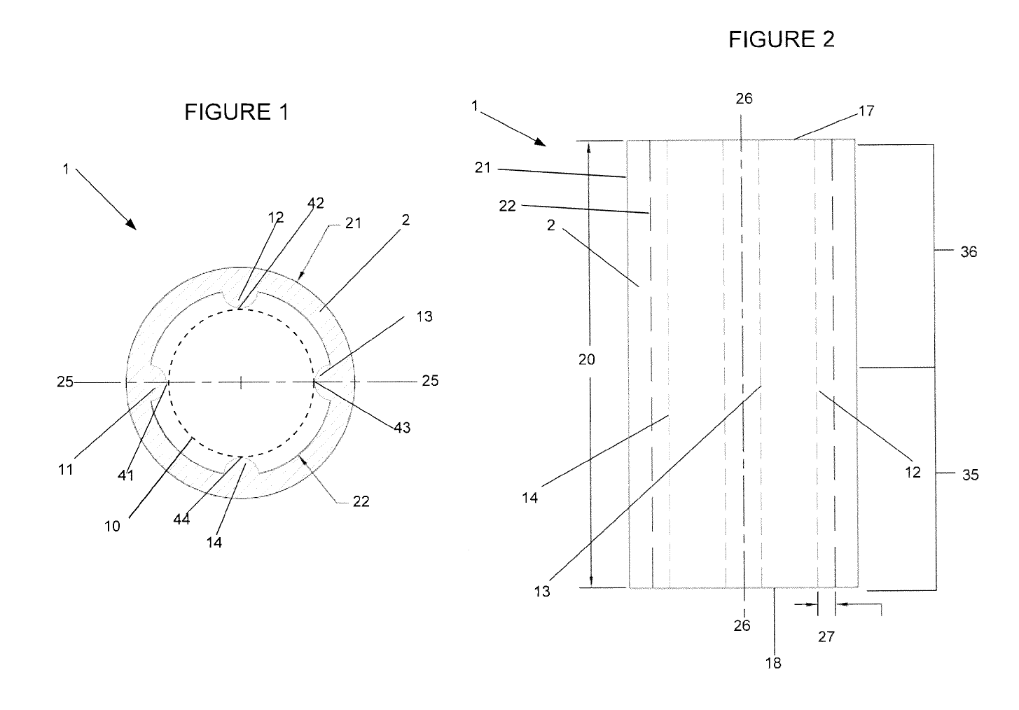

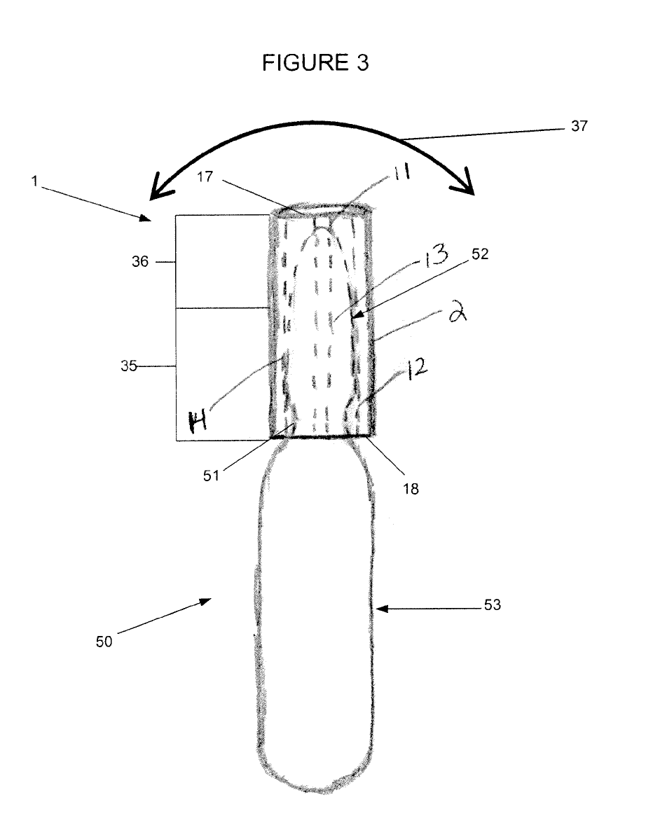

FIGS. 1-3 illustrate an embodiment of an ampoule breakage device 1 for opening an ampoule 50. The ampoule breakage device 1 may include a main body portion 2 and at least four protrusions, ridges, or fins 11, 12, 13, and 14. The ampoule breakage device 1 is configured to encase a tip 52 of the ampoule 50 (FIG. 3). In some embodiments, the ampoule breakage device may include 3 ridges.

The main body portion 2 preferably is in the general shape of a hollow cylinder that includes an inner cylindrical wall 22 and an outer cylindrical wall 21 (FIG. 1). As demonstrated in FIG. 1, inner wall 22 has a diameter that is smaller than the diameter of outer wall 21. The inner and outer wall 21, 22 may be any suitable diameter. The diameter of the inner and outer walls 21, 22 may depend on the size of the ampoule 50. For example, inner wall 22 may have a diameter ranging from approximately 0.353 to 0.382 inches and outer wall 21 may have a diameter ranging from approximately 0.590±0.010 inches or 0.575±0.010 inches. In some embodiments, the diameter of inner wall 22 may be approximately 0.375±0.007 inches for a 10 ml ampoule 50 and 0.360±0.007 inches for a 5 ml ampoule. In some embodiments, the diameter of outer wall 21 may be approximately 0.590±0.010 inches for a 10 ml ampoule and 0.575±0.010 inches for a 5 ml ampoule.

The main body portion 2 may be made from suitable materials having a durometer soft enough to permit some flexibility. For example, the main body portion 2 may be made of plastic, such as polyvinyl chloride, having a 90 shore A durometer. Other materials could be used, but preferably have a hardness similar to or softer than a 90 shore A durometer. Preferably, the durometer is softer than type D, but is sufficiently hard to suit the appropriate use of the product. The flexible material allows for the ampoule breakage device 1 to better grip the tip 52 of the ampoule 50 than rigid ampoule breakage devices composed of materials having a durometer substantially greater than 90 shore A. The better grip of the ampoule breakage device 1 helps ensure that the tip 52 of the ampoule 50 remains in the ampoule breakage device 1 after the tip 52 breaks off from the base 53 of the ampoule 50.

The main body portion 2 may be any suitable height 20 along a lateral axis 26-26 of the main body portion 2 (FIG. 2). For example, the height 20 of the main body portion 2 may be approximately 1.625±0.0625 inches. Preferably, the height 20 of the main body portion 2 is long enough to encase the tip 52 of the ampoule 50 when the ampoule breakage device 1 encases the ampoule 50. The tip 52 includes a collar or neck 51 where the ampoule 50 preferably breaks when the ampoule breakage device 1 is used to remove the tip 52 of the ampoule 50 from the ampoule 50. The height 20 of the main body portion 2 may be the same or substantially the same regardless of the size (e.g. 5 ml, 10 ml) of the ampoule.

The ridges 11, 12, 13, and 14 may extend or project from inner wall 22 of the ampoule breakage device 1 (FIG. 1) to define an annulus 10 have a diameter that is smaller than the diameter of inner wall. Ridges 11, 12, 13, and 14 may project a substantially uniform distance for the entirety of the ridge such that the diameter of annulus 10 is substantially constant. Ridges 11, 12, 13, and 14 may be coupled to the ampoule breakage device 1 or may be integrally formed with the ampoule breakage device 1. Preferably, the ridges 11, 12, 13, 14 are integrally formed with the ampoule breakage device 1 and are composed of the same material to reduce manufacturing costs. Device 1 may be formed by extrusion in accordance with various embodiments. In some embodiments, ridges 11-14 may be composed of a material distinct from main body portion 2 and may have a harder durometer than body portion 2.

In some embodiments, at least four ridges 11, 12, 13, 14 may project from the inner circumference 22 (FIGS. 1 and 3). Alternatively, more than four ridges may project from the inner circumference 22 in some embodiments. Ridges 11, 12, 13, and 14 in the ampoule breakage device 1 ensures that the tip 52 of the ampoule 50 remains in the ampoule breakage device 1 once the tip 52 breaks off from the base 53. The ridges positioned around the inner circumference 22 may be evenly spaced from one another to balance the forces exerted on the ampoule 50 when a user attempts to break the tip 52 of the ampoule 50 from the base 53 (FIG. 3) of the ampoule 50 at the collar 51 with the ampoule breakage device 1. As shown in FIGS. 1-2, for example, the center of each of the ridges 11, 12, 13, and 14 may be positioned along a lateral 26-26 or longitudinal axis 25-25 of the ampoule breakage device 1.

Ridges 11, 12, 13, and 14 may comprise various suitable shapes that allows a portion of the ridges to abut the tip 52 of the ampoule 50 when the ampoule breakage device 1 encases the ampoule 50 and to ensure that the tip 52 the ampoule 50 remains within the ampoule breakage device 1 after breaking off from the base 53 of the ampoule 50. Generally, some of the bottom portion 35, and not the top portion 36, (FIG. 2) of the ridges abuts the ampoule 50. Ridges 11, 12, 13, and 14 may each comprise a semi-cylindrical shape (FIG. 1), in accordance with some embodiments. When the ridges 11, 12, 13, and 14 each comprise a semi-cylindrical shape, each of the ridges 11, 12, 13, 14 may have a radius 27 of about 0.020±0.005 inches. Alternatively, one or more of the ridges may comprise a different shape from the other ridges. For example, if there are four ridges then two of the ridges may comprise a semi-cylindrical shape and two of the ridges may comprise a shape other than a semi-cylindrical shape. Other exemplary shapes may include a triangular or frustoconical shape. In alternative embodiments, the distance of the ridges from the inner circumference 22 varies so more or substantially all of the length of the ridges abuts the tip 52 of the ampoule 50 when the ampoule breakage device 1 encases the ampoule 50.

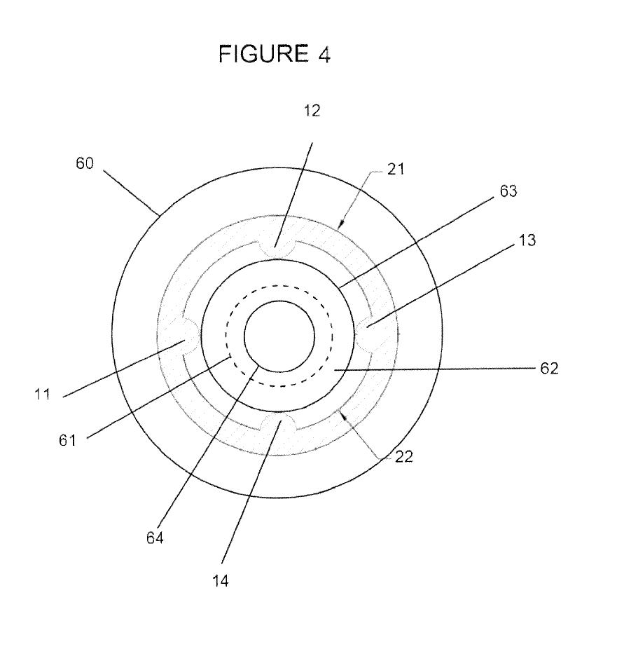

Ampoule breakage devices in accordance with various embodiments disclosed herein include ridges that engage an ampoule with a small surface area of the ridge, such as the tip of the ridge. Engaging the ampoule with the small surface area is accomplished through the use of a ridge that forms a tip projecting radially outward such that tip engages a peripheral portion of an ampoule tip. The tip may be in the form of a point, the edge of a curve that projects the most far radially inward, or a flat top of a narrowing ridge. A tip or pointed portion 41, 42, 43, and 44 of each of the ridges 11, 12, 13, and 14 abuts the ampoule 50 when the ampoule breakage device 1 encases the ampoule 50 (FIGS. 1 and 4). Ampoule breakage devices in accordance with various inventive embodiments include ridges that engage an ampoule with a small surface area of the ridge. Engaging the ampoule with the small surface area is accomplished through the use of a ridge that forms a tip for engagement with the ampoule. The tip may he in the form of a point, the edge of a curve, or even a flat of a narrowing ridge. The pointed portions 41, 42, 43, and 44 allow for a more secure connection between the ampoule breakage device 1 and the ampoule 50 so that the ampoule breakage device 1 more easily breaks the tip 52 of the ampoule 50 from the base 53 of the ampoule 50 as a result of the increased surface contact between the ridges 11, 12, 13, 14 and tip 52 and so that the tip 52 of the ampoule 50 remains within the ampoule breakage device 1 after the tip 52 breaks off from the base 53 of the ampoule 50. The retention of the tip 52 within the ampoule breakage device 1 after the tip 52 breaks off from the base 53 of the ampoule 50 helps prevent injury to the operator of the ampoule breakage device 1.

The ampoule breakage device 1 may include a first end 17 and a second end 18 that is distal from the first end 17 (FIGS. 2-3). The first end 17 may be at the top of the ampoule breakage device 1. The second end 18 may be at the bottom of the ampoule breakage device 1. The ridges 11, 12, 13, 14 may be configured to extend longitudinally from the first end 17 to the second end 18 (FIGS. 2-3). The extension of the ridges 11, 12, 13, and 14 from the first end 17 to the second end 18 increases the surface area where the ridges 11, 12, 13, and 14 abut the tip 52 of the ampoule 50, thereby enabling the user to more easily break the tip 52 from the base 53 at the collar 51 of the ampoule 50 (FIG. 3) and enabling the tip 52 to remain within the ampoule breakage device 1 after the tip 52 breaks off from the base 53 of the ampoule 50 at the collar or neck 51 via rotation along arc 37. Additionally, the extension of ridges 11, 12, 13, and 14 from the first end 17 to the second end 18, provides an easy to manufacture (due at least in part to the uniform configuration) ampoule breakage device that is operable with a variety of ampoule types through the ability of the ampoule breakage device to grip the tip at a wide range of positions along the length of the device. For example, if a first ampoule had a bulbous portion of a first diameter that was closer to the neck than a second ampoule having a bulbous portion of the same first diameter that was closer to the apex of the ampoule, the same ampoule breakage device would be operable and as effective with the first ampoule as with the second ampoule. Alternatively, ridges 11, 12, 13, and 14 may not extend from the first end 17 to the second end 18. In some embodiments, the longitudinal ridges, such as ridges 11-14, may only extend along a portion of the ampoule breakage device 1.

FIG. 4 is a top, cross-sectional view of an ampoule breakage device positioned about the tip of an ampoule in accordance with an exemplary embodiment. As demonstrated in FIG. 4, ampoule breakage device 1 is configured such that largest bulbous portion 63 of the tip of ampoule 60 is firmly gripped by longitudinal ridges 11, 12, 13, and 14 of ampoule breakage device 1 because the diameter of annulus 10 (shown in FIG. 1) is substantially the same as or slightly smaller than bulbous portion 63. As further demonstrated in FIG. 4, neck 61 of the tip of ampoule 60 may have a smaller diameter than portion 63. In some embodiments, the tip of ampoule 60 may include more than one bulbous portion (e.g. portions 64 and 63), but the ampoule breakage device, which may have a constant cross sectional area the entire length of device 1, may be selected such that annulus 10 is substantially the same diameter or slightly smaller than the diameter of portion 63 adjacent to neck 61. The flexibility of device 1 permits slight radial deflections such that ridges 11, 12, 13, and 14 deflect slightly outward to fit around portion 63, but maintain a substantial amount of force and pressure radially inward on the tip of ampoule 60 so that upon removal of the tip (i.e. by breaking at neck 61), the tip is maintained securely within device 1. The small surface area of ridges 11, 12, 13, and 14 allow the ridges to maintain a high force on the tip of ampoule 60 at the contact points of ridges 11, 12, 13, and 14 with portion 63, which force is enabled by reinforcement of inner wall 22 from which ridges 11, 12, 13, and 14 project and along which ridges 11, 12, 13, and 14 extend in a longitudinal direction.

In some embodiments, the ampoule breakage device 1 may be composed of a reddish material (e.g. biohazard red, sharps injury prevention red), which material may be at least partially opaque. The coloring of the ampoule breakage device 1 ensures that operators of the device and other personnel know that the ampoule breakage device is a biohazard once the tip 52 is removed from the ampoule 50 and within the ampoule breakage device 1. The partial opaqueness allows an operator to easily observe if a broken tip is contained within the ampoule breakage device.

As utilized herein, the terms “approximately,” “about,” “substantially” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and are considered to he within the scope of the disclosure.

It should be noted that the term “exemplary” as used herein to described various embodiments is intended to indicate that such embodiments are possible examples, representations, and/or illustrations of possible embodiments (and such term is not intended to connote that such embodiments arc necessarily extraordinary or superlative examples).

For the purpose of this disclosure, the term “coupled” means the joining of two members directly or indirectly to one another. Such joining may be stationary or moveable in nature. Such joining may be achieved with the two members or the two members and any additional intermediate members being integrally formed as a single unitary body with one another or with the two members or the two members and any additional intermediate members being attached to one another. Such joining may be permanent in nature or may be removable or releasable in nature.

It should he noted that the orientation of various elements may differ according to other exemplary embodiments, and that such variations are intended to be encompassed by the present disclosure. It is recognized that features of the disclosed embodiments can be incorporated into other disclosed embodiments.

It is important to note that the constructions and arrangements of the ampoule breakage device or components thereof as shown in the various exemplary embodiments are illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited in the claims. For example, elements shown as integrally formed may be constructed of multiple parts or elements, the position of elements may be reversed or otherwise varied, and the nature or number of discrete elements or positions may he altered or varied. The order or sequence of any process or method steps may be varied or re-sequenced according to alternative embodiments. Other substitutions, modifications, changes and omissions may also be made in the design, operating conditions and arrangement of the various exemplary embodiments without departing from the scope of the present disclosure.

All literature and similar material cited in this application, including, but not limited to, patents, patent applications, articles, hooks, treatises, and web pages, regardless of the format of such literature and similar materials, are expressly incorporated by reference in their entirety. In the event that one or more of the incorporated literature and similar materials differs from or contradicts this application, including but not limited to defined terms, term usage, describes techniques, or the like, this application controls.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

Also, the technology described herein may be embodied as a method, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should he understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

The claims should not be read as limited to the described order or elements unless stated to that effect. It should be understood that various changes in form and detail may be made by one of ordinary skill in the art without departing from the spirit and scope of the appended claims. All embodiments that come within the spirit and scope of the following claims and equivalents thereto are claimed.

1. An apparatus for removing a tip of an ampoule, the apparatus comprising:
a hollow cylindrical body including an outer cylindrical wall having a first diameter and an inner cylindrical wall having a second diameter, the second diameter smaller than the first diameter, the hollow cylindrical body having a durometer less than or equal to 90 shore A; and
a plurality of ridges projecting radially inward from the inner cylindrical wall of the hollow cylindrical body, the plurality ridges extending longitudinally on the inner cylindrical wall.

2. The apparatus of claim 1, wherein the plurality of ridges extend longitudinally from a first end of the inner cylindrical wall to a second end of the cylindrical wall.

3. The apparatus of claim 1, wherein the plurality of ridges project radially inward to a third diameter from the first end to the second end.

4. The apparatus of claim 1, wherein the second diameter of the inner cylindrical wall is constant from the first end of the cylindrical wall to the second end.

5. The apparatus of claim 1, wherein each ridge in the plurality of ridges has a semi-cylindrical cross section.

6. The apparatus of claim 1, wherein the hollow cylindrical body is composed of a flexible polyvinyl chloride.

7. The apparatus of claim 1, wherein the hollow cylindrical body is colored red.

8. The apparatus of claim 7, wherein the hollow cylindrical body is at least partially opaque.

9. The apparatus of claim 1, wherein the plurality of ridges includes at least one of 3 and 4 ridges.

10. The apparatus of claim 1, wherein each ridge in the plurality of ridges projects 0.025 inches or less radially inward from the inner cylindrical wall.

11. An apparatus for removing a tip of an ampoule, the apparatus comprising:
a hollow cylindrical body including an outer cylindrical wall having a first diameter and an inner cylindrical wall having a second diameter, the second diameter smaller than the first diameter; and
a plurality of ridges projecting radially inward from the inner cylindrical wall of the hollow cylindrical body such that a tip of each ridge in the plurality of ridges is configured to engage a peripheral portion of the tip of the ampoule, the plurality of ridges extending longitudinally along the inner cylindrical wall.

12. A method of breaking a tip of an ampoule, the method comprising:
sliding an ampoule breakage device over the tip of the ampoule, the ampoule breakage device having a hollow cylindrical body including an outer cylindrical wall, an inner cylindrical wall, and a plurality of longitudinal ridges extending along the cylinder, the plurality of longitudinal ridges projecting radially inward from the inner cylindrical wall of the hollow cylindrical body, the plurality of longitudinal ridges projecting from the inner cylindrical wall a uniform distance such that an annulus is defined having a diameter limited by the plurality of ridges, the diameter of the annulus defined by the plurality of longitudinal ridges and substantially corresponding to a diameter of a largest bulbous portion of the tip of the ampoule, the ampoule breakage device slid over the tip of the ampoule until a first end of ampoule breakage device extends to at least a neck of the ampoule and the plurality of ridges engage the largest bulbous portion of the tip of the ampoule, the hollow cylindrical body having a durometer less than or equal to 90 shore A; and
rotating the ampoule breakage device to break the tip of the ampoule at the neck, whereby the tip of the ampoule is securely maintained in the ampoule breakage device through engagement of the largest bulbous portion of the tip of the ampoule with the plurality of longitudinal ridges.

13. The method of claim 12, wherein the plurality of ridges project from the inner cylindrical wall a uniform distance.

14. The method of claim 12, wherein the plurality of longitudinal ridges extend from a first end of the inner cylindrical wall to a second end of the inner cylindrical wall.

15. The method of claim 12, wherein each ridge in the plurality of ridges has a semi-cylindrical cross section.

16. The method of claim 12, wherein the hollow cylindrical body is composed of a flexible polyvinyl chloride.

17. The method of claim 12, wherein the hollow cylindrical body is colored red.

18. The method of claim 17, wherein the hollow cylindrical body is at least partially opaque.

19. The method of claim 12, wherein the plurality of ridges includes four ridges.

20. The method of claim 12, wherein each ridge in the plurality of ridges projects 0.025 inches or less radially inward from the inner cylindrical wall.
